(19) United States
(12) Patent Application Publication
(10) Pub. No.: US 2026/0091570 A1
(43) Pub. Date: Apr. 2, 2026

(54) ARTICLES PRODUCED FROM REPROCESSED FOAM AND METHODS OF MANUFACTURE THEREOF

(71) Applicant: Inteva Products, LLC, Troy, MI (US)

(72) Inventors: Kenneth Gassman, Troy, MI (US); Kevin Lyons, Troy, MI (US); Xinhua He, Bloomfield Hills, MI (US)

(21) Appl. No.: 19/336,678

(22) Filed: Sep. 23, 2025

Related U.S. Application Data
(60) Provisional application No. 63/701,284, filed on Sep. 30, 2024.

(51) Int. Cl. B32B 7/022; B29C 48/00; B29K 23/00; B29K 105/04; B29K 105/24; B32B 5/02; B32B 5/18; B32B 5/24; B32B 27/06; B32B 27/08; B32B 27/12; B32B 27/32; C08L 23/12

(52) U.S. Cl. CPC B32B 7/022; B29C 48/0021; B32B 5/02; B32B 5/18; B32B 5/245; B32B 27/065; B32B 27/08; B32B 27/12; B32B 27/32; C08L 23/12; B29K 2023/12; B29K 2105/046; B29K 2105/24; B29K 2713/00; B32B 2250/04; B32B 2250/242; B32B 2262/0253; B32B 2266/025; B32B 2266/08; B32B 2305/72; B32B 2307/54; C08L 2203/14; C08L 2207/04; C08L 2312/00

(57) ABSTRACT

Disclosed herein is a multilayer article comprising a first layer comprising a first thermoplastic polyolefin; and where the first layer is in contact with a fourth layer that comprises an olefin polymer with a peak melting point of 130 to 170° C.; where the first layer has a lower elastic modulus than the fourth layer, where the elastic modulus is measured as per ASTM D638; where the multilayer article is operative to be used as a panel in the interior of an automobile.

### CROSS REFERENCE TO RELATED APPLICATIONS

This application claims priority to U.S. Provisional Application having Ser. No. 63/701,284, filed on Sep. 30, 2024, the entire contents of which are hereby incorporated by reference.

### BACKGROUND

This disclosure relates to articles produced from reprocessed foam and to methods of manufacture thereof.

Recycling polymeric materials is becoming increasingly important and economically valuable. There has been considerable progress in recycling thermoplastic polymeric materials but recycling cross-linked (also known as thermoset) materials still poses significant challenges. Once a polymer is cross-linked it will not melt again and this feature has been a key obstacle to recycling cross-linked materials. Additionally, cross-linked materials, particularly cross-linked foamed materials, are frequently bonded to thermoplastics. Attempts to reuse these materials have typically involved separating the thermoplastic from the cross-linked foam—a time consuming and labor intensive process. Recycling a cross-linked material has involved various chemical methods of reducing the number of cross links. These methods are generally expensive and can negatively impact the environment. When these methods are applied to cross-linked foam there is the additional issue of gas release from the foam cells which can negatively impact the final product. Even when the cross-linked material is processed sufficiently for reuse, residual cross linking agents can also affect the final product negatively.

There remains a need in the art for a method of reprocessing cross-linked materials, especially foamed cross-linked material.

### SUMMARY

Disclosed herein is a multilayer article comprising a first layer comprising a first thermoplastic polyolefin; and where the first layer is in contact with a fourth layer that comprises an olefin polymer with a peak melting point of 130 to 170° C.; where the first layer has a lower elastic modulus than the fourth layer, where the elastic modulus is measured as per ASTM D638; where the multilayer article is operative to be used as a panel in the interior of an automobile.

Disclosed herein is a method of manufacturing a multilayer article, the method comprising extruding a first layer; where the first layer comprises a first thermoplastic polyolefin; unspooling a fourth layer from a feed roll; where the fourth layer comprises an olefin polymer with a peak melting point of 130 to 170° C.; where the first layer has a lower elastic modulus than the fourth layer; and feeding the first layer and the fourth layer to a nip gap in a roll mill; where the first layer and the fourth layer are laminated to form a multilayer article.

Disclosed herein too is a method of recycling a multilayer article, the method comprising:
comminuting a multilayer article (A) comprising:
   a) a first layer comprising a first thermoplastic polyolefin; and
   b) a fourth layer comprising an olefin polymer with a peak melting point of 130 to 170° C.; or
comminuting a multilayer article (B) comprising:
   i) a first layer comprising a first thermoplastic polyolefin;
   ii) a second layer comprising a second thermoplastic polyolefin;
   iii) a third layer comprising a third thermoplastic polyolefin; and
   iv) a fourth layer comprising an olefin polymer with a peak melting point of 130-170° C.; where the first thermoplastic polyolefin is different from the second thermoplastic polyolefin; and melt blending a powder of a respective comminuted multilayer article (A) or (B) with additional thermoplastic polyolefin in a melt processor; where the powder of each of the respective comminuted multilayer article (A) or (B) comprises at least 50% by weight of a thermoplastic polyolefin.

### BRIEF DESCRIPTION OF THE FIGURES

FIG. 1 is a schematic depiction of an exemplary multilayer article;

FIG. 2 is a simplified schematic depiction of an exemplary process for manufacturing the multilayer article; and

FIG. 3 is a schematic depiction of an exemplary multilayer article of the FIG. 1; where the multilayer article is bonded with a crosslinked polypropylene and a thermoplastic polyolefin substrate.

### DETAILED DESCRIPTION

### Definitions

Foamed cells refer to the cellular structure within foam materials, where gas bubbles are trapped within a solid matrix, creating a lightweight, porous structure.

Cross-linked polypropylene (sometimes referred to by its acronym XLPP) is commonly used in applications such as automotive parts, insulation materials, and foam products, particularly where durability and stability under harsh conditions is desired. It is a modified form of polypropylene (PP) where covalent bonds or “cross-links” are formed between the polymer chains. This cross-linking process enhances the materials performance by making it more resilient to thermal, chemical, and mechanical stresses. It essentially strengthens the materials structure, providing better resistance to heat deformation, impact, and cracking, while also improving its durability under prolonged exposure to extreme conditions. Cross-linked polypropylene foam is a specialized material known for its use in industries where lightweight, durability, and thermal insulation properties are desired.

The term “olefin” refers to a class of hydrocarbons that contain at least one carbon-carbon double bond (C═C). Olefins are polymerized to produce polyolefins.

Polyolefins are sometimes referred to herein as “olefin polymers”.

### Detailed Description

Disclosed herein is a multilayered article that functions like an artificial leather and that can be used as panels in an automobile. The panels are soft to the touch and may be used in the interior of automobiles either by themselves (in which case the resulting part is soft and pliable) or in conjunction with a rigid backing (in which case the resulting part is rigid). In an embodiment, the multilayered article may comprise 2 or more layers, preferably 3 or more layers and preferably 4 or more layers (a multilayered article) each of which comprises a thermoplastic polyolefin. The thermoplastic polyolefin is present in an amount of greater than at least 50 wt % of each layer, based on a total weight of the layer. In an embodiment, the thermoplastic polyolefin is present in an amount of greater than 50 wt %, preferably greater than 55 wt %, and more preferably greater than 60 wt %, based on the total weight of the multilayered article.

The polyolefins used in the respective layers may be thermoplastic or crosslinked (sometimes referred to as thermosets). In an embodiment, the polyolefins used in each layer is a thermoplastic. This enables easy recycling of the multilayered article. Because each of the layers comprise a polyolefin, the multilayered articles can be advantageously recycled for further use (during the course of its lifecycle or after its lifecycle is completed) with a minimal loss of material to a landfill.

Disclosed herein too is a method of manufacturing the multilayered articles. In an embodiment, a first method of manufacturing the multilayered article comprising coextruding at least 2 or more layers and preferably 3 or more layers (each of which comprises a polyolefin) to form a first laminate that is bonded to a fourth layer (hereinafter termed a backing layer) which also comprises an polyolefin in a roll mill to form the multilayered article. In an embodiment, the fourth layer comprises an olefin polymer with a peak melting point of 130 to 170° C.

Disclosed herein too is a method of recycling the aforementioned multilayered article. When in use, the multilayered article may optionally be disposed on a crosslinked polypropylene foam (sometimes referred to as an XLPP foam) and/or a rigid thermoplastic polyolefin substrate (sometimes referred to as a TPO substrate) (which acts as a carrier) to form a rigid multilayered article. The crosslinked polypropylene foam and the rigid thermoplastic polyolefin substrate impart strength and geometrical shape and form to the multilayered article (first layer 102 in combination with any of the remaining layers 104, 106 and 108) to form a three-dimensional object that may be used in the interior of automobile. The rigid multilayered article thus has a soft surface (provided by the layer 102) but has structural rigidity and can be load bearing if desired (because of the crosslinked polypropylene foam and/or the rigid thermoplastic polyolefin substrate). In an embodiment, the thermoplastic polyolefin is present in an amount of greater than at least 50 wt %, preferably greater than 55 wt %, and more preferably greater than 60 wt %, based on the total weight of the rigid multilayered article.

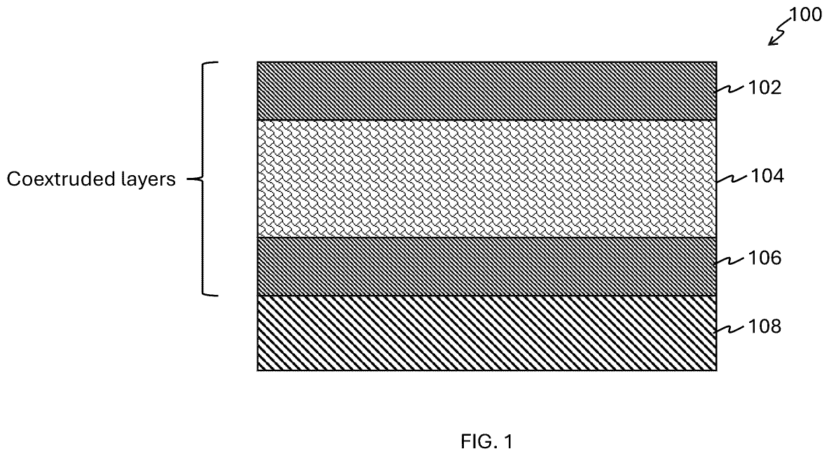

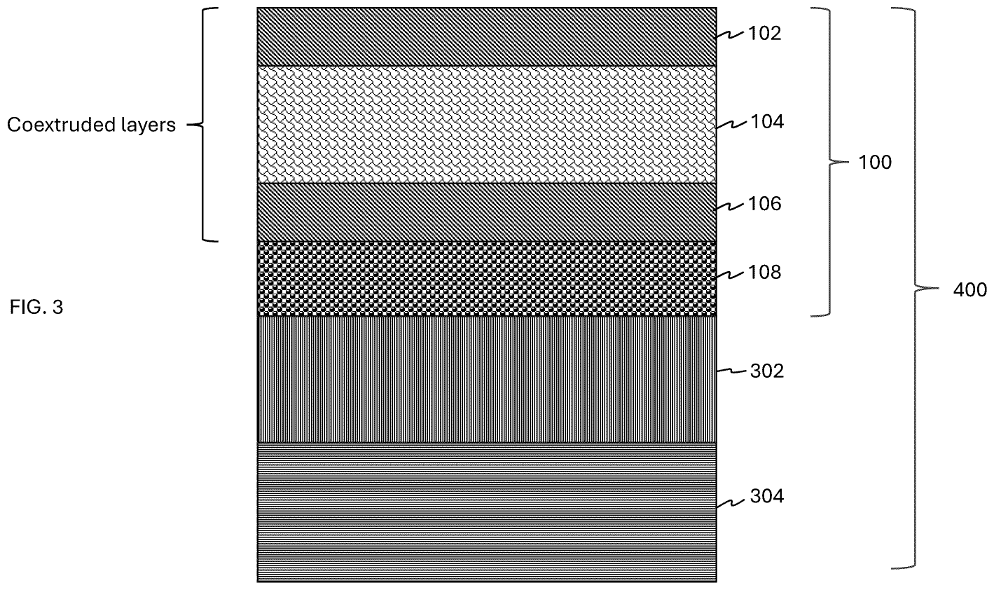

The multilayered article or the rigid multilayered article may advantageously be subjected to recycling in its entirety to form recycled pellets which may then be used in part to form the multilayered article disclosed herein. Since each layer of the rigid multilayered article comprises polyolefins, it can advantageously be completely recycled in a single process without much loss of material in the form of scrap. Furthermore, the lack of a substantial amount of crosslinked material in the multilayer article or in the rigid multilayered article results in minimal phase separation between the various polymeric components that are added during recycling to facilitate conversion of the recycled scrap to a reusable thermoplastic polyolefin. The multilayered article or the rigid multilayered article is substantially devoid of polymers other than polyolefins, which minimizes phase separation, inhomogeneity and incompatibility during reprocessing, thereby reducing scrap and defects that would otherwise normally occur. Minimal material needs to be discharged to a landfill. The recycled polyolefin may then be used in any of the layers of the multilayered article depicted in the FIGS. 1 and 3.

FIG. 1 is a schematic depiction of an exemplary multilayered article 100 that comprises a plurality of layers 102, 104, 106 and 108 at least one of which has a composition that is different from at least one other layer. In an embodiment, the multilayered article comprises at least one layer 102 (referred to herein as the first layer 102) that is in contact with layer 108 (referred to herein as the fourth layer 108). In an embodiment, the article comprises at least two different layers-first layer 102 and second layer 104 that are disposed on fourth layer 108, but can contain at least three layers first layer 102, second layer 104 and third layer 106 that are disposed on fourth layer 108. Layers 104 and 106 may be optional layers (e.g., the multilayered article 100 can be devoid of them). In one preferred embodiment, the multilayered article comprises at least four different layers first layer 102, second layer 104, third layer 106 and fourth layer 108. Each of the four different layers—the first layer 102, second layer 104, third layer 106 and fourth layer 108 comprise polyolefins. In an embodiment, the first layer 102, the second layer 104 and the third layer 106 comprise thermoplastic elastomers. In yet another embodiment, the second layer 102 comprises a foamed thermoplastic elastomer.

As may be seen from the FIG. 1, the first layer 102 is in direct contact with the second layer 104, while the second layer 104 when present is in direct contact with both the first layer 102 and the third layer 106 on opposed faces. The third layer is in direct contact with the second layer 104 and the fourth layer 108 on opposing faces. The fourth layer 108 is in direct contact with the third layer 106 on at least one of its faces. As may be seen from the FIG. 1, in an embodiment, the first layer 102 and the fourth layer 108 are outer layers of the multilayer article.

As will be detailed further, each of the foregoing layers (first layer 102, optional second layer 104, optional third layer 106 and fourth layer 108) may be disposed on a crosslinked polypropylene foam

In an embodiment, each of the layers—first layer 102, second layer 104 and third layer 106 may have the same of different chemical compositions though they may have varying physical structures. For example, the first layer 102 and the third layer 106 may have the same or different thicknesses but are both solid films (with substantially no porosity), while the second layer 104 is a foamed layer (with a porosity that is greater than 25 volume percent, preferably greater than 40 volume percent, and more preferably greater than 50 volume percent) that may have a different thickness from either first layer 102 or the third layer 106. All of these features are discussed below.

In an embodiment, the first layer 102 and the optional third layer 106 have a higher elastic modulus than the elastic modulus of the second layer 104 (as determined according to ASTM D638), which comprises a foam. The elastic modulus of the fourth layer 108 is higher than that of the first layer 102, the second layer 104 and the third layer 106.

The first layer 102 may have the same or different composition as the third layer 106. The third layer 106 may be optional. The layers 102 and 106 are elastomeric (the each have an elastic modulus of 0.01 megapascals (MPa) to less than 100 MPa, preferably less than 10 MPa as determined by ASTM D638) and may each comprise a thermoplastic elastomer. In an embodiment, the first layer 102 may comprise a first thermoplastic elastomer while the third layer 106 may comprise a third thermoplastic elastomer. In an embodiment, the first thermoplastic elastomer may have the same chemical composition as the third thermoplastic elastomer. In another embodiment, the first thermoplastic elastomer may have a different chemical composition than the third thermoplastic elastomer.

The first thermoplastic elastomer comprises a polypropylene-based elastomer, an ethylene-based elastomer, a polypropylene and a filler. In an embodiment, the filler may be optional. The first layer 102 and the third layer 106 each contain at least 50% by weight of a thermoplastic olefin polymer and are both are in the form of solid films that a devoid of any substantial porosity. Both of the layers 102 and 106 comprise flexible films that are preferably soft to the touch.

As used herein, the term “propylene-based elastomer” refers to a polymer that contains more than 50 mole percent of polymerized propylene monomer (based on the total amount of polymerizable monomers) and contains at least one comonomer.

In embodiments herein, the propylene-based elastomer is a propylene copolymer or a combination of a polypropylene homopolymer with a polypropylene copolymer. In some embodiments, the propylene-based elastomer is a propylene/olefin copolymer. The polypropylene homopolymer may be isotactic, atactic, or syndiotactic. In some embodiments, the propylene-based elastomer is an isotactic polypropylene homopolymer.

The propylene/olefin copolymer may be random or block. The propylene/olefin copolymer comprises than or equal to 100 percent, for example, at least 70 percent, or at least 80 percent, or at least 90 percent, or at least 92 percent, or at least 95 percent, by weight of the units derived from propylene; and (b) less than 30 percent, for example, less than 25 percent, or less than 20 percent, or less than 10 percent, or less than 8 percent, or less than 5 percent, by weight of units derived from one or more alpha-olefin comonomers. In further embodiments, the propylene-based elastomer may be a combination of one or more propylene homopolymers, one or more propylene copolymers, or a combination of one or more propylene homopolymers and one or more propylene copolymers.

In embodiments herein where the propylene-based elastomer comprises at least one alpha-olefin comonomer, the alpha-olefin comonomers have no more than 20 carbon atoms. For example, the alpha-olefin comonomers may have 3 to 10 carbon atoms, or 3 to 8 carbon atoms. Exemplary alpha-olefin comonomers include, but are not limited to, ethylene, 1-butene, 1-pentene, 1-hexene, 1-heptene, 1-octene, 1-nonene, 1-decene, and 4-methyl-1-pentene. The one or more alpha-olefin comonomers may, for example, be selected from the group consisting of ethylene, 1-butene, 1-hexene, and 1-octene; or in the alternative, from the group consisting of ethylene. In embodiments herein, the propylene-based elastomer may or may not be a homopolymer, copolymer, or interpolymer.

The propylene-based elastomer can be made using any method for polymerizing propylene and, optionally, one comonomer. For example, gas phase, bulk or slurry phase, solution polymerization or any combination thereof can be used. Polymerization can be a one stage or a two or multistage polymerization process, carried out in at least one polymerization reactor. For two or multistage processes different combinations can be used, e.g. gas-gas phase, slurry-slurry phase, slurry-gas phase processes. Suitable catalysts can include Ziegler-Natta catalysts, a single-site catalyst (metallocene or constrained geometry), or non-metallocene, metal-centered, heteroaryl ligand catalysts, or combinations thereof.

The propylene-based elastomer may be used in the first layer 102 or third layer 106 in an amount of 50 to 70 wt %, preferably 55 to 65 wt %, based on a total weight of either the first layer 102 or the third layer 106 respectively.

In addition to the propylene-based elastomer, the first layer 102 or the third layer 106 comprises an ethylene-based elastomer. The ethylene-based elastomer comprises (a) less than or equal to 100 percent, for example, at least 70 percent, or at least 80 percent, or at least 90 percent, or at least 92 percent, or at least 95 percent, by weight of the units derived from ethylene; and (b) less than 30 percent, for example, less than 25 percent, or less than 20 percent, or less than 10 percent, or less than 8 percent, or less than 5 percent, by weight of units derived from one or more alpha-olefin comonomers. As used herein, the term “ethylene-based elastomer” refers to a polymer that contains more than 50 mole percent of polymerized ethylene monomer (based on the total amount of polymerizable monomers) and, optionally, may contain at least one comonomer.

In embodiments herein where the ethylene-based elastomer comprises at least one alpha-olefin comonomer, the alpha-olefin comonomers have no more than 20 carbon atoms. For example, the alpha-olefin comonomers may have 3 to 10 carbon atoms, or 3 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. The one or more alpha-olefin comonomers may, for example, be selected from the group consisting of propylene, 1-butene, 1-hexene, and 1-octene; or in the alternative, from the group consisting of 1-hexene and 1-octene. In embodiments herein, the ethylene-based elastomer may or may not be a homopolymer, copolymer, or interpolymer.

The ethylene-based elastomer can be made via gas-phase, solution-phase, or slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof. In some embodiments, gas or solution reactors are used. The catalysts used to make the ethylene-based elastomer described herein may include Ziegler-Natta, metallocene, constrained geometry, single site catalysts, or combinations thereof. For example, the ethylene-based elastomer may be a LLDPE, such as, a znLLDPE, which refers to linear polyethylene made using Ziegler-Natta catalysts, a uLLDPE or “ultra linear low density polyethylene,” which may include linear polyethylenes made using Ziegler-Natta catalysts, or a mLLDPE, which refers to LLDPE made using metallocene or constrained geometry catalyzed polyethylene.

The ethylene-based elastomer may be used in the first layer 102 or third layer 106 in an amount of 10 to 30 wt %, preferably 15 to 25 wt %, based on a total weight of either the first layer 102 or the third layer 106 respectively.

The first layer 102 and the third layer 106 further comprise a polypropylene homopolymer. It is to be noted that this polypropylene homopolymer is in addition to any polypropylene homopolymer that may be a part of the polypropylene-based elastomer that is detailed above. The polypropylene homopolymer may be isotactic, atactic, or syndiotactic. In some embodiments, the polypropylene homopolymer is an isotactic polypropylene homopolymer. The polypropylene homopolymer may also contain small amounts of a random copolymer polypropylene (which is a copolymer of propylene with ethylene or an alpha-olefin comonomer having 3 to 20 carbon atoms), injection molded polypropylene or high melt strength polypropylene. The alpha-olefin comonomer having 3 to 20 carbon atoms are already listed above and will not be repeated here in the interests of brevity. In an embodiment, high melt strength polypropylene is manufactured using a polypropylene with long chain branching. In an embodiment, the long chain branching can be produced by electron beam irradiation, reactive compounding, or a combination thereof.

The polypropylene homopolymer may be used in the first layer 102 or the third layer 106 in an amount of 5 to 25 wt %, preferably 10 to 20 wt %, based on a total weight of either the first layer 102 or the third layer 106 respectively.

The first layer 102 and/or the third layer 106 may also contain fillers and additives. “Filler” includes reinforcing fillers such as glass fibers and beads, carbon fibers, carbon nanotubes, carbon blacks, polymer fibers (e.g., polyester fibers, polyaramid fibers, polyimide fibers, polyetherimide fibers, or the like, or a combination thereof), clay, or the like, or a combination thereof. These fillers may be in the form of nanoparticles (having average particles sizes of less than 100 nanometers) or micrometer-sized particles (having average particle sizes of greater than or equal to 100 nanometers). The fillers may have a unimodal particle size distribution or a multimodal (e.g., bimodal, trimodal, and so on) particle size distribution.

In addition, the first layer 102 and/or the third layer 106 may contain additives, such as, antistatic agents, color enhancers, dyes, lubricants, fillers, such as, TiO₂ or CaCO₃, opacifiers, nucleators, processing aids, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof.

The one or more fillers and additives can be included in the first layer 102 and/or the third layer 106 at levels typically used in the art to achieve their desired purpose. In some examples, the one or more additives are included in amounts ranging from 0 to 10 wt %, 1 to 5 wt %, 1.5 to 4 wt % of the total weight of the first layer 102 and/or the third layer 106 respectively.

As noted above, the first layer 102 may be directly disposed on the fourth layer 108 or may alternatively be disposed on the second layer 104 and the third layer 106. When the first layer 102 is directly bonded to the fourth layer 108, the first layer has a thickness of 0.10 to 0.7 millimeters, preferably 0.2 to 0.6 millimeters.

When the first layer 102 is bonded to the second layer 104 and the third layer 106, the first layer 102 and the optional third layer 106 may have the same thickness or one layer may have a different thickness from the other. In an embodiment, the first layer 102 has a thickness of 0.05 to 0.35 millimeters. In an embodiment, the third layer 106 has a thickness of 0.05 to 0.35 millimeters.

The second layer 104 is preferably a foamed layer that comprises a second thermoplastic elastomer. The second thermoplastic elastomer may be the same or different from the first thermoplastic elastomer (used in the first layer 102) or the third thermoplastic elastomer (used in the third layer 106). The second layer 104 is preferably a foamed layer that has the same composition as the first layer 102 and the third layer 106 except that it contains a blowing agent and/or a nucleating agent (prior to foaming) that facilitates the formation of cells in the process of foam formation. Residues of the blowing agent and the nucleating agent may be present in the foam after the blowing has occurred. The foam may be an open cell foam, a closed cell foam, or a foam that has both closed cells and open cells. In an embodiment, the foam is preferably a closed foam. The foam may be a soft, flexible foam or a rigid foam depending upon the application. In a preferred embodiment, the foam is a soft, flexible foam that comprises a thermoplastic polyolefin. The foam layer 104 is not crosslinked.

The blowing agents may be physical blowing agents, chemical blowing agents, or a combination thereof. In a preferred embodiment, the blowing agent is a chemical blowing agent. Both types of blowing agents are described below.

Physical blowing agents typically undergo phase separation from the organic polymer (in which they are dissolved) upon experiencing a change in environmental conditions to produce the foam, while chemical blowing agents are those that undergo reaction or decomposition upon experiencing a change in environmental conditions to release a gas, which results in the formation of the foam.

A blowing agent is a substance which is capable of producing a cellular structure via a foaming process in a variety of materials that undergo hardening or phase transition, such as organic polymers. They are typically applied when the blown material (e.g., the organic polymer) is in a liquid or molten stage. The cellular structure in the polymer reduces density while increasing relative stiffness of the original organic polymer. Blowing agents or related mechanisms to create holes in a matrix producing cellular materials, have been classified as follows:
Physical blowing agents include chlorofluorocarbons (CFCs), hydrochlorofluorocarbons
   (HCFCs), hydrocarbons (e.g., pentane, butane, isopentane, cyclopentane, or the like), and liquid or supercritical carbon dioxide. The bubble/foam-making process is irreversible and endothermic, i.e., it needs heat (e.g., from a melt process or the chemical exotherm due to cross-linking) or a change in pressure, to volatilize the liquid blowing agent.

Chemical blowing agents include azodicarbonamide, hydrazine and other nitrogen-based organic polymers for thermoplastic and elastomeric polymeric foams, and sodium bicarbonate for other thermoplastic polymeric foams. Gaseous products and other byproducts are formed by a chemical reaction of the chemical blowing agent, promoted by the heat of the foam production process or a reacting polymer's exothermic heat. Since the blowing reaction occurs while forming low molecular weight compounds acting as the blowing gas, additional exothermic heat is also released.

Mixed physical/chemical blowing agents may also used to produce foamed organic polymers. Here both the chemical and physical blowing agents are used in tandem to balance each other out with respect to thermal energy released and absorbed, thereby minimizing temperature rise in the organic polymer and preventing thermal degradation of the organic polymer.

Examples of suitable physical blowing agents may be methyl fluoride, methyl chloride, difluoromethane, methylene chloride, perfluoromethane, or the like; hydrocarbons such as acetylene, ammonia, butane, butene, isobutane, isobutylene, propane, dimethylpropane, ethane, methane, trimethylamine, pentane, cyclopentane, hexane, propane, propylene, alcohols, ethers, ketones; or the like, or a combination thereof.

In another embodiment, a thermally expandable microsphere can be used as the blowing agent. The microsphere is formed of a gas proof polymeric shell (e.g., polyacrylonitrile or polyvinylidene chloride) that encapsulates a (cyclo)aliphatic hydrocarbon (e.g., liquid isobutene). When the thermally expandable microspheres are subjected to temperatures of about 50° C. to about 200° C., the polymeric shell softens and the (cyclo)aliphatic hydrocarbon expands, thereby promoting an increase in the volume of the microspheres. When expanded, the microspheres have a diameter 3.5 to 4 times their original diameter, as a consequence of which their expanded volume is about 50 to 60 times greater than their initial volume in the unexpanded state. An example of such thermally expandable microspheres are the EXPANCEL® DU microspheres which are marketed by Nouryon Industries.

The blowing agent is present in the second layer prior to foaming in an amount of 1 to 5 wt %, preferably 1.25 to 2.0 wt %, based on a total weight of the second layer 104. Residual blowing agent (the amount of residual agent in the foam after blowing) is 0.01 to 2 wt %, based on a total weight of the foamed second layer 104.

The second layer 104 may also contain a nucleating agent. Nucleating agents typically are used with chemical blowing agents. They facilitate the nucleation of cells, which eventually grow in size via binodal decomposition to form the foam. Nucleating agents for foaming in polymers are additives that promote the formation of gas bubbles during the foaming process, leading to a more uniform cell structure and improved mechanical properties. These agents help control the size, distribution, and density of the foam cells, enhancing the final properties of the polymer foam. Examples of nucleating agents include talc, calcium carbonate, silica, sodium bicarbonate, organic salts, clay, titanium dioxide, metal oxides (e.g., zinc oxide, magnesium oxide, or the like), carbon dioxide gas, nitrogen gas, or the like, or a combination thereof.

The nucleating agent may optionally be present in the second layer 104 prior to blowing in an amount of 0.5 to 2.5 wt %, preferably 1 to 2 wt %, based on a total weight of the second layer 104.

In an embodiment, the foam may be first manufactured by mixing the polymer with a suitable blowing agent such that the polymer-blowing agent combination exist in a single phase. The polymer-blowing agent combination is retained at a pressure and temperature that is effective to retain the combination in a single phase until the combination is ready for use. When desired, the combination is pumped through a die or poured into the cavities and the pressure and/or temperature is changed to facilitate binodal decomposition which results in the nucleation and growth of cells in the polymer to form the foam. When the pressure and/or temperature in the cavities is changed, the blowing agent nucleates and grows in the polymer matrix resulting in the formation of a polymeric foam.

Alternatively, when a chemical blowing agent is deployed, the polymer-blowing agent combination is retained at a pressure and temperature that is effective to retain the combination in a single phase until the combination is ready for use. When desired, the combination is pumped through a die or poured into the cavities and the pressure and/or temperature is changed to facilitate decomposition of the blowing agent, which releases a gas that results in the nucleation and growth of cells in the polymer to form the foam.

In an embodiment, the second layer 104 has a thickness of 0.15 to 0.90 millimeters.

The second layer 104 has a porosity of 60 to 90 volume percent, preferably 70 to 88 volume percent, and more preferably 75 to 85 volume percent. The pores have an average cell size that varies from 15 to 100 micrometers.

In an embodiment, the fourth layer 108 comprises an olefin polymer with a peak melting point of 130 to 170° C. The fourth layer 108 (which is sometimes referred to as a backing layer) generally comprises a polypropylene homopolymer or a polypropylene copolymer. Both polypropylene homopolymers and polypropylene copolymers are detailed above and will not be described again in the interests of brevity.

The fourth layer 108 may be in the form of a solid film or in the form of a woven or non-woven textile. In an embodiment, the fourth layer 108 is in the form of a circular knit fabric. A circular knit fabric is a type of fabric that is produced using a circular knitting machine rather than a flatbed knitting machine. In circular knitting, the fabric is knitted in a continuous tube, as the machine's needles move up and down while also moving in a circular manner. The tube of fabric is slit open along its length. It may be washed/finished on a tenter frame. This results in a seamless, stretchy fabric that can be used for a wide variety of applications, especially in garments that require comfort and flexibility. The fourth layer 108 typically has a higher elastic modulus than that of the first layer 102.

In an embodiment, when the first layer 102 is directly bonded to the fourth layer 108, the fourth layer has a thickness of 0.3 to 1.2 millimeters, preferably 0.5 to 0.9 millimeters. On the other hand, when the first layer is bonded to the fourth layer through the second and third layers, the fourth layer has a thickness of 0.1 to 0.5 millimeters, preferably 0.15 to 0.45 millimeters.

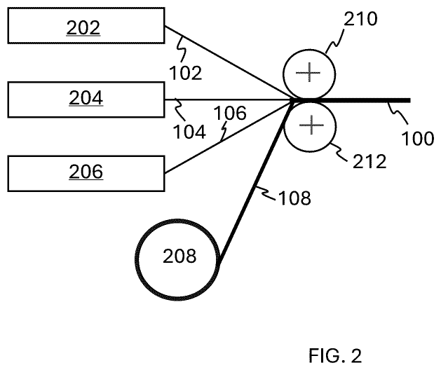

In one embodiment, in one manner of manufacturing the multilayered article 100, the composition for the first layer 102 and optionally the second layer 104 and the third layer 106 are disposed in three separate extruders 202, 204 and 206 as seen in FIG. 2. FIG. 2 is a simplified schematic depiction of an exemplary manufacturing set-up that is used to produce the multilayered article 100. The first layer 102 and the third layer 106 may be extruded as solid films while the second layer 104 may be extruded as a foam.

The first layer 102 and optionally the layer 104 and 106 may be co-extruded into the “nip gap” of a roll mill along with the fourth layer 108. The “nip gap” (the distance between the opposing roll mills 210 and 212) is adjusted to put the desired pressure on the first through fourth layers—102, optionally 104, optionally 106 and 108 to form the multilayered article. The fourth layer 108 may be unspooled from a feed roll 208 and fed to the nip gap. It may alternatively be coextruded and fed to the nip gap to be laminated to form the multilayered article 100. As may be seen in the FIGS. 1 and 3, the first layer and the fourth layer each lie on an outer face of the second layer and the third layer respectively. The inner face of the second layer contacts an inner face of the third layer.

The roll mill may be a 2-roll mill or a 3-roll mill. 3-roll mills are preferred. During the roll milling process, the pressure imposed on the various layers should be adequate to facilitate lamination and provide the appropriate bond strength between the various layers (102 through 108) while not destroying the quality of the second layer 104 (the foam layer). Too high of a compressive force in the nip could reduce porosity in the foam layer, which is undesirable.

In an embodiment, the multilayered article comprising two through four layers is then disposed on a crosslinked polypropylene foam (sometimes referred to as an XLPP foam) and/or a rigid thermoplastic polyolefin substrate (sometimes referred to as a TPO substrate) (which acts as a carrier) to form a rigid multilayered article. The crosslinked polypropylene layer may be a foam or alternatively, a solid layer that is not porous. FIG. 3 depicts the multilayered article 100 bonded to a crosslinked polypropylene 302 and a rigid thermoplastic polyolefin substrate 304 to form the rigid multilayered article 400.

In one embodiment, the bonding of the multilayered article 100 to the layers of crosslinked polypropylene 302 and the rigid thermoplastic polyolefin substrate 304 may be conducted by a process that involves cutting, sewing and wrapping. When the bonding of the multilayered article 100 to the layers of crosslinked polypropylene 302 and the rigid thermoplastic polyolefin substrate 304 is conducted by a process that involves cutting, sewing and wrapping, the layer of crosslinked polypropylene 302 has a thickness of 1.0 to 1.5 millimeters, preferably 1.1 to 1.4 millimeters, while the rigid thermoplastic polyolefin substrate 304 has a thickness of 2.0 to 3.0 millimeters, preferably 2.2 to 2.8 millimeters.

In another embodiment, the bonding of the multilayered article 100 to the layers of crosslinked polypropylene 302 and the rigid thermoplastic polyolefin substrate 304 may be conducted by a thermoforming process. When the bonding of the multilayered article 100 to the layers of crosslinked polypropylene 302 and the rigid thermoplastic polyolefin substrate 304 is conducted by a thermoforming process, the layer of crosslinked polypropylene 302 has a thickness of 2.0 to 3.0 millimeters, preferably 2.2 to 2.8 millimeters, while the rigid thermoplastic polyolefin substrate 304 has a thickness of 2.0 to 3.0 millimeters, preferably 2.2 to 2.8 millimeters. The film thickness and the thickness of individual layers is measured perpendicular to the direction at which the extrudate emanates from the die of the extruder.

In an embodiment, the multilayer article or the rigid multilayer article may be recycled after its life cycle of use is completed. Since the entire multilayer article comprises a polyolefin, it can be recycled without any part being discarded due to lack of compatibility. As noted above, the presence of a thermoplastic polyolefin in an amount of greater than 50 wt %, preferably greater than 55 wt %, preferably greater than 60 wt %, based on a total weight of the multilayer article or the rigid multilayer article makes the recycling process efficient and reduces scrap due to a lack of compatibility with materials added downstream in the recycling process.

In an embodiment, the multilayer article or the rigid multilayer article after use is optionally shredded in a shredding machine to a size that facilitates introduction into the hopper of an extruder. The shredded article is then introduced into a melt processor along with other thermoplastic polyolefins (such as those described above) to produce a new blend of thermoplastic polyolefins that can be reused in the multilayer articles described in the FIGS. 1 and 3.

Suitable melt processors include extruders, both single screw extruders and multiple screw extruders. In addition to this requirement, and dependent on the target application of the melt-processable material, the multilayer article (or the rigid multilayer article) may use more stringent processing to achieve the desired level of trapped gas in the melt-processable material. For example, a sheet application may require the processed multilayer article (or the rigid multilayer article) to have an average particle size that is less than or equal to the average cell size of the polymeric foam (i.e., second layer 104). Tailored properties (e.g., hardness) are possible based on the average particle size of the processed material. A processed foam having a larger average particle size may result in a softer feel or unique haptics/appearance due to the higher level of trapped gases remaining in the melt during processing. Conversely, an extremely demanding application may require the multilayer article (or the rigid multilayer article) material to have a very small average particle size to ensure negligible levels of trapped gases are present during thermal processing. Processing includes any process that can attain the appropriate particle size such as shredding, grinding, cryo-grinding or a combination thereof. In addition to these exemplary processes, separation, consolidation (i.e., densification), or mixing (e.g., with an abrasive particle to aid in the size reduction) may also be used.

The processed multilayer article (or the rigid multilayer article) has domain size, under melt mixing conditions, less than or equal to the processing spaces of the melt processor. Domain size is defined as the volume occupied by a discrete portion of the processed multilayer article (or the rigid multilayer article) material. This domain may or may not comprise a trapped gas. The domain may or may not have a regular shape under melt mixing conditions. Additionally, the domain may deform under melt mixing conditions to allow passage through the processing spaces. Processing spaces are defined as those spaces in which the melt mixed material moves through. For example, in an extruder the processing spaces would include the barrel (particularly the spaces between the screw(s) and the barrel), a melt filter (if used) and holes in the die (if used). The domain size under melt mixing conditions is less than or equal to the smallest processing spaces of the melt processor in order to prevent clogging and blockages.

During the recycling, thermoplastic materials and optional compatibilizer(s) are combined with the processed multilayer article (or the rigid multilayer article) material in the melt processor. The desired characteristics of the melt-processable materials will ultimately depend on the specific material system. The additional materials should be readily melt-processable and, ideally, fully compatible with all present materials. For example, a propylene-ethylene copolymer (e.g., a thermoplastic polyolefin) would be a suitable thermoplastic polymer to be added to a system containing cross-linked polypropylene foam or a cross-linked polypropylene foam bonded to a polyethylene skin. A compatibilizer is defined herein as an additive which facilitates the distribution of the processed multilayer article (or the rigid multilayer article) throughout the matrix of the melt-processable polymeric material and stabilizes the morphology of the final product. The choice of a compatibilizer is dependent upon the composition of the processed multilayer article (or the rigid multilayer article) and the composition of the matrix of the final product. Polymeric compatibilizers include block/graft copolymers, polymers with polar side groups, and reactive functional polymers. Also contemplated are reactive compounds (reactive compatibilizers) which aid in the in-situ formation of copolymers. Examples of such reactive compatibilizers include unsaturated carboxylic acids and the like.

Examples of unsaturated carboxylic acids are maleic acid, fumaric acid, itaconic acid, methacrylic acid, crotonic acid, malonic acid, succinic acid, glutaric acid, adipic acid, pimelic acid, suberic acid, azelaic acid, sebacic acids, citraconic acid, or the like, or a combination thereof. Examples of derivatives of unsaturated carboxylic acids are maleic anhydride, citraconic anhydride, itaconic anhydride, malonic anhydride, succinic anhydride, glutaric anhydride, adipic anhydride, pimelic anhydride, suberic anhydride, azelaic anhydride, methyl acrylate, methyl methacrylate, ethyl acrylate, ethyl methacrylate, butyl acrylate, butyl methacrylate, glycidyl acrylate, glycidyl methacrylate, or the like, or a combination thereof. Maleic anhydride is the preferred grafting compound.

When the processed material comprises a processed thermoplastic material (e.g., such as, for example, the multilayer article (or the rigid multilayer article) described herein) no additional thermoplastic material may be desired although additional thermoplastic may be added. If additional thermoplastic is included in the composition. it may be the same as or different from the processed thermoplastic material. For example, if the processed thermoplastic material is a polyethylene the additional thermoplastic material may be polyethylene, polypropylene, or a polyolefin copolymer. A compatibilizer, as described above, may also be included in the melt mixing composition.

During melt mixing, the melt processor design and/or conditions are chosen to minimize or eliminate the effects of any residual blowing agents, cross linking agents, or a combination thereof. The melt mixing composition may also include rheology modifiers to assist with extraction of volatiles during the melt mixing process. Modifying the rheology of the melt mixing composition can facilitate removal of volatiles through the use of vacuum. Rheology modifiers may also increase the viscosity and/or melt strength of the composition after the removal of the volatiles. Common rheology modifiers include commercially available plasticizers that enhance the fluidity of a material. Certain classes of plasticizers include linear or branched phthalates, trimellitates, adipates, polymerics, and terephthalates. Processing conditions that will have an effect on the quality of the final material include, but are not limited to: screw design, screw speed, barrel temperature profile, die design, pellet size, use of an underwater pelletizer, cutter design and cutting speed, or the like.

It is also contemplated that the processed polymeric material may be melt mixed to form a pelletized processed polymeric material and the pelletized processed polymeric material may be melt mixed with an additional thermoplastic material. Similarly, a processed cross-linked polymeric foam may be melt mixed with a first thermoplastic to form a pelletized material which is then melt mixed with a second thermoplastic to form the melt-processable material. Rheology modifiers and compatibilizers can be added during any melt mixing step.

In an embodiment, the recycled thermoplastic polyolefins may be reused in the any of the layers of the multilayer article described in the FIGS. 1 and 3.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A multilayer article comprising:
a first layer comprising a first thermoplastic polyolefin; and
where the first layer is in contact with a fourth layer that comprises an olefin polymer with a peak melting point of 130 to 170° C.; where the first layer has a lower elastic modulus than the fourth layer, where the elastic modulus is measured as per ASTM D638; where the multilayer article is operative to be used as a panel in the interior of an automobile.

2. The multilayer article of claim 1, where the first thermoplastic olefin comprises a propylene-based elastomer in an amount of 50 to 70 wt % and an ethylene-based elastomer in an amount of 10 to 30 wt %, based on a total weight of the first layer.

3. The multilayer article of claim 1, further comprising a second layer, where the second layer is disposed between the first layer and the fourth layer, where the second layer comprises a foam that comprises a second thermoplastic polyolefin; where the second thermoplastic olefin is different in chemical composition from the first thermoplastic polyolefin.

4. The multilayer article of claim 3, where the second thermoplastic polyolefin comprises a propylene-based elastomer in an amount of 50 to 70 wt % and an ethylene-based elastomer in an amount of 10 to 30 wt % and blowing agent residue, based on a total weight of the second layer.

5. The multilayer article of claim 3, where the foam comprises closed cells, open cells, or a combination of closed cells and open cells.

6. The multilayer article of claim 3, where the foam comprises closed cells.

7. The multilayer article of claim 3, further comprising a third layer, where the third layer lies between the second layer and the fourth layer.

8. The multilayer article of claim 7, where the third layer has a same composition as the first layer.

9. The multilayer article of claim 7, where the second layer has a greater thickness than the first layer and the third layer.

10. The multilayer article of claim 7, wherein the first layer, the second layer, the third layer and the fourth layer all comprise thermoplastic polyolefins that are melt processable.

11. The multilayer article of claim 1, further comprising a crosslinked polypropylene layer and a thermoplastic substrate layer to form a rigid multilayer article; where the crosslinked polypropylene layer lies between the fourth layer and the thermoplastic substrate layer; and where the first layer contacts a face of the fourth layer opposite the face that contacts the crosslinked polypropylene layer.

12. The multilayer article of claim 7, further comprising a crosslinked polypropylene layer and a thermoplastic substrate layer to form a rigid multilayer article; where the crosslinked polypropylene layer lies between the fourth layer and the thermoplastic substrate layer; and where the third layer contacts a face of the fourth layer opposite the face that contacts the crosslinked polypropylene layer.

13. The multilayer article of claim 1, where the fourth layer comprises a fabric or a film; and wherein the fourth layer comprises a polypropylene homopolymer or copolymer.

14. The multilayer article of any one of claims 11 or 12, where the crosslinked polypropylene layer comprises a foam.

15. A method of manufacturing a multilayer article, the method comprising:
extruding a first layer; where the first layer comprises a first thermoplastic polyolefin;
unspooling a fourth layer from a feed roll; where the fourth layer comprises an olefin polymer with a peak melting point of 130 to 170° C.; where the first layer has a lower elastic modulus than the fourth layer; and
feeding the first layer and the fourth layer to a nip gap in a roll mill; where the first layer and the fourth layer are laminated to form a multilayer article.

16. The method of claim 15, further comprising coextruding a second layer and a third layer and feeding the second layer and the third layer to the nip gap in the roll mill; where the second layer and the third layer both comprise thermoplastic polyolefins; and where the first layer and the fourth layer each lie on an outer face of the second layer and the third layer respectively and where an inner face of the second layer contacts and inner face of the third layer.

17. The method of claim 15, further comprising bonding the multilayer article to a crosslinked polypropylene layer and a thermoplastic substrate layer to form a rigid multilayer article; where the crosslinked polypropylene layer lies between the fourth layer and the thermoplastic substrate layer; and where the first layer contacts a face of the fourth layer opposite the face that contacts the crosslinked polypropylene layer.

18. The method of claim 16, further comprising bonding the multilayer article to a crosslinked polypropylene layer and a thermoplastic substrate layer to form a rigid multilayer article; where the crosslinked polypropylene layer lies between the fourth layer and the thermoplastic substrate layer; and where the third layer contacts a face of the fourth layer opposite the face that contacts the crosslinked polypropylene layer.

19. A method of recycling a multilayer article, the method comprising:
comminuting a multilayer article (A) comprising:
a) a first layer comprising a first thermoplastic polyolefin; and
b) a fourth layer comprising an olefin polymer with a peak melting point at 130 to 170° C.; or
comminuting a multilayer article (B) comprising:
i) a first layer comprising a first thermoplastic polyolefin;
ii) a second layer comprising a second thermoplastic polyolefin;
iii) a third layer comprising a third thermoplastic polyolefin; and
iv) a fourth layer comprising an olefin polymer with a peak melting point of 130 to 170° C.; where the first thermoplastic polyolefin is different from the second thermoplastic polyolefin; and
melt blending a powder of a respective comminuted multilayer article (A) or (B) with additional thermoplastic polyolefin in a melt processor; where the powder of each of the respective comminuted multilayer article (A) or (B) comprises at least 50% by weight of a thermoplastic polyolefin.

20. The method of claim 19, where each of the multilayer article (A) or (B) further comprises a crosslinked polypropylene layer and a thermoplastic substrate layer.
